(19) United States
(12) Patent Application Publication
(10) Pub. No.: US 2022/0288802 A1
(43) Pub. Date: Sep. 15, 2022

(54) HOLE PUNCHER

(71) Applicant: APEX MFG. CO., LTD., Taichung City (TW)

(72) Inventors: Jung-Yu WANG, Taichung City (TW); Chia-Tse CHEN, Taichung City (TW)

(21) Appl. No.: 17/198,607

(22) Filed: Mar. 11, 2021

(51) Int. Cl. B26F 1/36; B26F 1/14

(52) U.S. Cl. CPC B26F 1/36; B26F 1/14

(57) ABSTRACT

A hole puncher is provided, including: a frame, including a base and a guide portion, the base including at least one punching hole, the guide portion including at least one guide hole corresponding to the at least one punching hole, there being a distance between the punching hole and the guide hole; an operating lever, provably connected to the frame; at least one punching rod, driven by the operating lever, being relatively movable within the at least one guide hole and movable to come within or out from the at least one punching hole, each punching rod including a first straight section, a second straight section and a tapered section which is tapered from the first straight section toward the second straight section.

### BACKGROUND OF THE INVENTION

### Field of the Invention

The present invention relates to a hole puncher.

### Description of the Prior Art

In many fields, such as institutions, schools and offices, there are large number of paper documents or other objects to be punched. For archiving and storing, the paper documents are punched to form holes therethrough so as to facilitate the attachment of the paper documents to loose-leaf folders and other devices.

Generally speaking, a hole puncher is used to punch through the paper documents. The punching rod is driven by pressing the lever to penetrate through the paper documents, to form the through holes. The hole puncher is simple in structure, easy to operate and effective in punching, so it is widely used. However, when punching a large number of paper documents, the punching rod penetrates the large number of paper documents and the outer peripheral surface of the punching rod contacts the inner sides of the through holes of the large number of paper documents on a large area, resulting in that the punching rod and the lever are dragged by friction and cannot return automatically. As a result, it needs to manually return the lever by pulling up after every punching, which is extremely inconvenient, and time-consuming and labor-consuming.

The present invention is, therefore, arisen to obviate or at least mitigate the above-mentioned. disadvantages.

### SUMMARY OF THE INVENTION

The main object of the present invention is to provide a hole puncher which ensures the collimation and precision of movement of a punching rod so that the punching rod can retract easily and hardly be jammed within the article(s) to be punched.

To achieve the above and other objects, a hole puncher is provided, including: a frame, including a base and a guide portion, the base including at least one punching hole, the guide portion including at least one guide hole corresponding to the at least one punching hole, there being a distance between the punching hole and the guide hole; an operating lever, movably connected to the frame; at least one punching rod, driven by the operating lever, being relatively movable within the at least one guide hole and movable to come within or out from the at least one punching hole, each punching rod including a first straight section, a second straight section and a tapered section which is tapered from the first straight section toward the second straight section.

The present invention will become more Obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of a preferable embodiment of the present invention;

FIGS. 3 and 4 are partial cross-sectional views, taken along a first direction, showing operation of a preferable embodiment of the present invention;

FIGS. 5 to 8 are partial cross-sectional views, taken along a second direction, showing operation of a preferable embodiment of the present invention; and

FIG. 9 is a partial enlargement of a punching rod according to a preferable embodiment of the present invention.

### DETAILED DESCRIPTION OF THE PREFERRED EMBODIMENTS

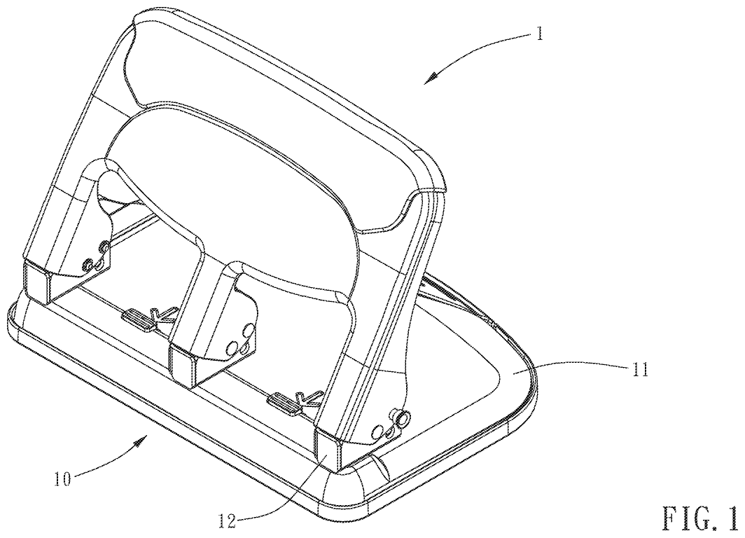

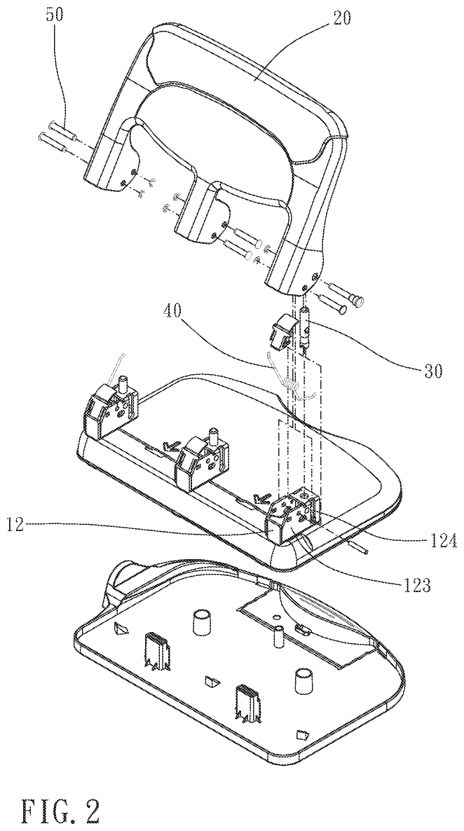

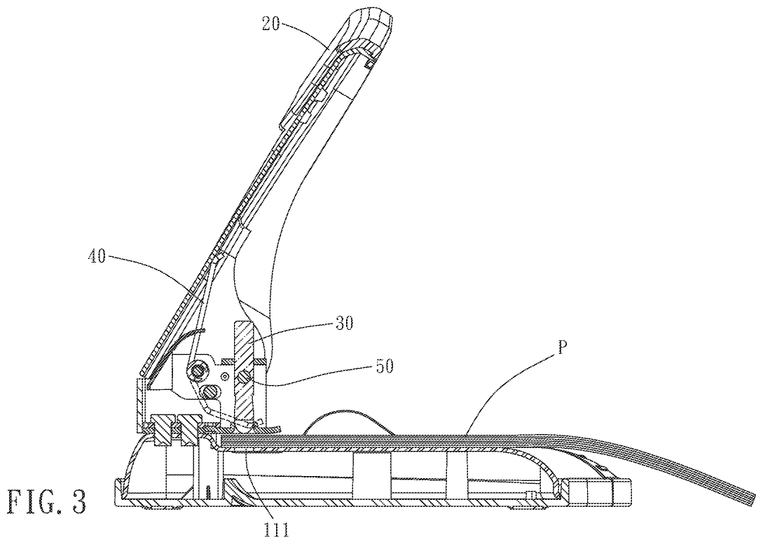

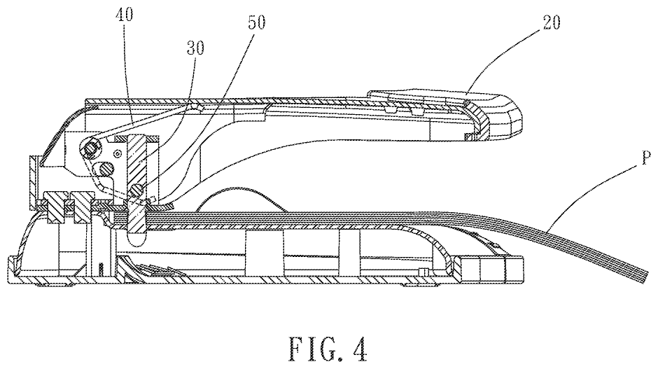

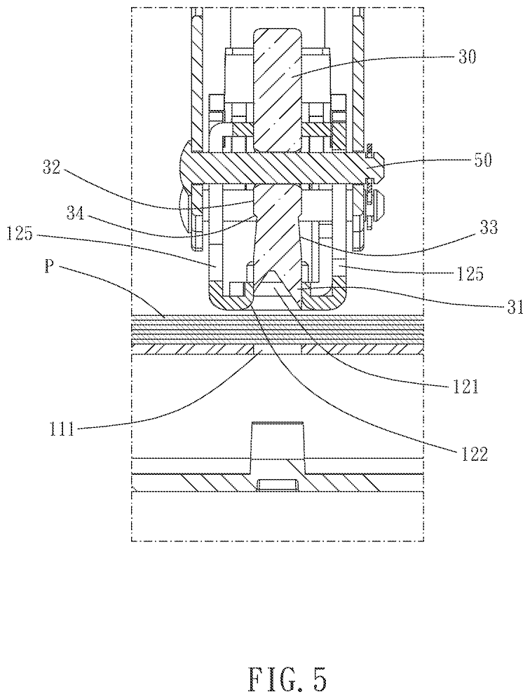

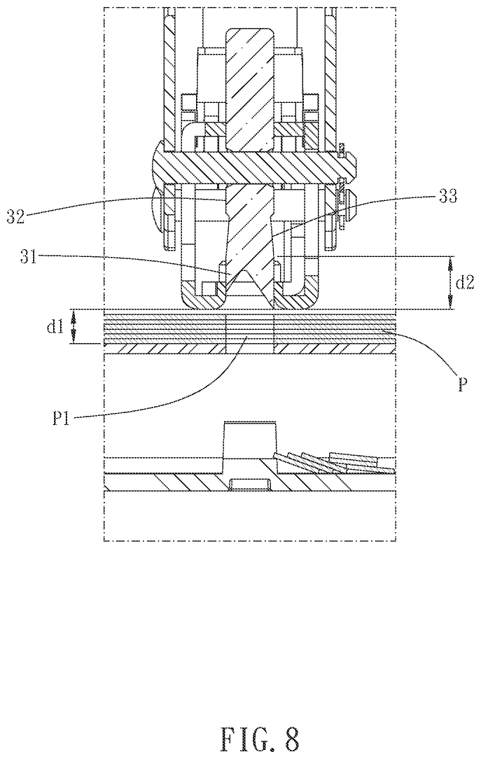

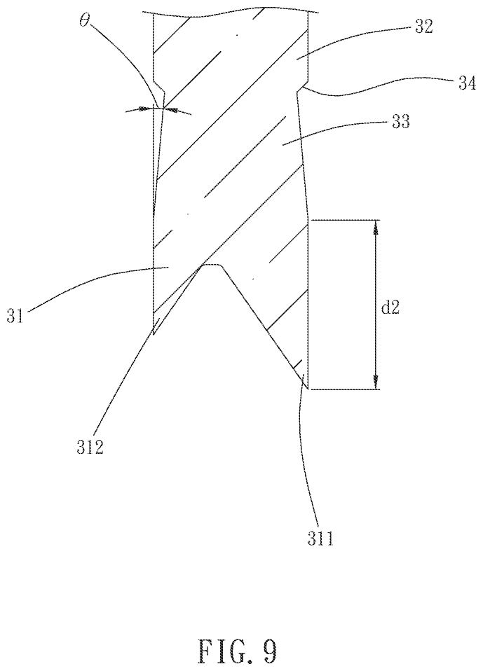

Please refer to FIGS. 1 to 9 for a preferable embodiment of the present invention. A hole puncher 1 of the present invention includes a frame 10, an operating lever 20 and at least one punching rod 30.

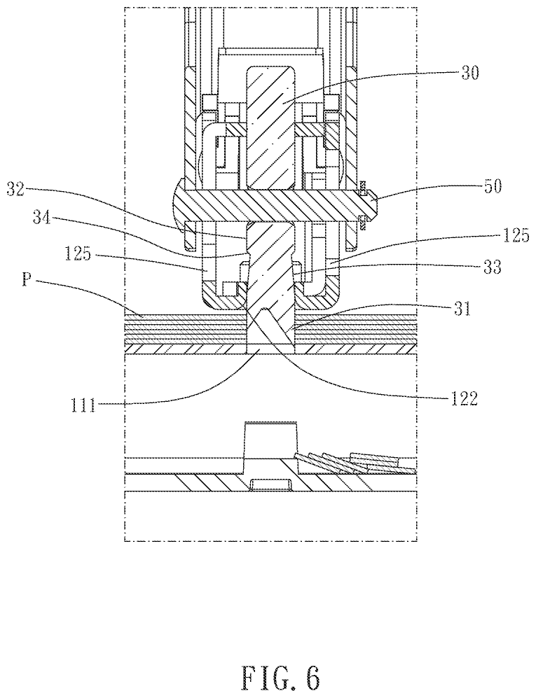

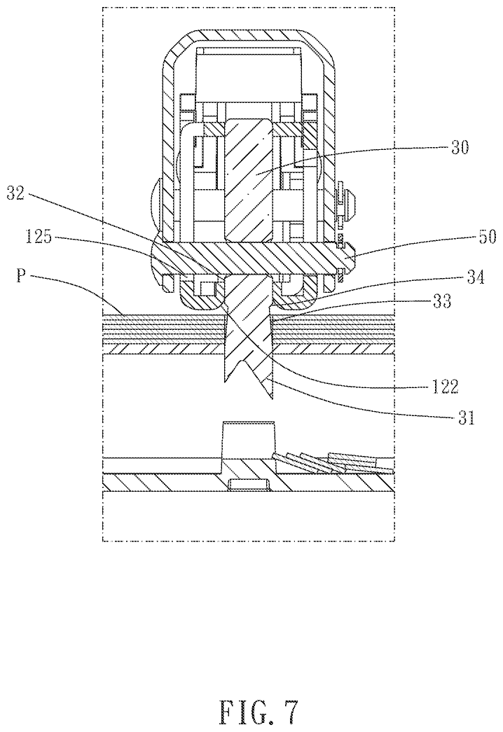

The frame 10 includes a base 11 and a guide portion 12, the base 11 includes at least one punching hole 111, the guide portion 12 includes at least one guide hole 121 corresponding to the at least one punching hole 111, and there is a distance d1 between the punching hole 111 and the guide hole 121. for receiving at least one article P to be punched (such as paper, sheet or plate member, or the like). The operating lever 20 is movably connected (pivoted, for example) to the frame 10. The at least one punching rod 30 is driven by the operating lever 20 and is relatively movable within the at least one guide hole 121 and movable to come within or out from the at least one punching hole 111. Each of the at least one punching rod 30 includes a first straight section 31, a second straight section 32 and a tapered section which is tapered from the first straight section 31 toward the second straight section 32. Preferably, the first straight section 31 has an extent d2 larger than the distance d1. Whereby, when the first straight section 31 punches and moves through the at least one article P to come into the punching hole 111, the first straight section 31 is guided by the guide hole 121 and the punching hole 111 (as shown in FIG. 6), and thus the first straight section31 does not tilt so that the hole edge of the punching hole 111 is free of being cut by the punching rod 30. Preferably, when the second straight section 32 is located within the guide hole 121, the first straight section 31 is located within the punching hole 111, which ensures the collimation and precision of movement of the punching rod 30. Furthermore, the tapered section 33 reduces frictional resistance with the at least one article P (especially in punching a larger amount of the articles P, as shown in FIG. 7), so the punching rod 30 can retract easily and hardly be jammed within the articles P.

Specifically, the frame 10 includes a plurality of said guide portions 12 and a plurality of said punching rods 30, and each of the plurality of said punching rods 30 further includes an expanded section 34 expanding from the tapered section 33 toward the second straight section 32, which can prevent the punching rod 30 from jamming within the at least one article P and can distribute stress on the punching rod 30 when pushing. The first straight section 31 and the second straight section 32 are cylindrical and have the same outer diametric dimension. The first straight section 31 and the second straight section 32 may be of any of other shapes. Preferably, at least one elastic member 40 is disposed between the operating lever 20 and the frame 10 so that the operating lever 20 can automatically return to its original position after operated. The tapered section 33 is movable to be located between one said punching hole 111 and one said guide hole 121 which correspond to each other. The tapered section 33 is preferably necked, in which after the at least one article P is penetrated by the first straight section 31 to form a through hole P1, the tapered section 33 is located within the through hole P which reduces friction and is advantageous for retraction of the punching rod 30 (FIG. 7). Preferably, the tapered section 33 is inclined to the first straight section 31 at an inclined angle θ of 5 degrees to 30 degrees; and the tapered section 33 includes a largest outer diametric dimension and a smallest outer diametric dimension, and the smallest outer diametric dimension is 0.05 mm to 3.00 mm smaller than the largest outer diametric dimension. Each said guide hole 121 may include an expanding opening 122 gradually expanding in a direction toward one said punching hole ill, which provides good guiding for the punching rod 30.

In this embodiment, the first straight section 31 of each said punching rod 30 includes a long blade portion 311 and a short blade portion 312 which are movable through one said punching hole 111, fir entire penetration through the at least one article P. The long blade portion 311 is closer to the punching hole 111 than the short blade portion 312, and the long blade portion 311 and the short blade portion 312 are in a high-low arrangement relative to the base 11, which effectively and labor-savingly for penetrating the at least one article P. The guide portion 12 further includes at least one pair of side walls 123, and each said side wall 123 includes a guide slot 124. The at least one punching rod 30 is slidably disposed within the guide slot 124 of the at least one pair of side walls 123 by at least one shaft 50, to stabilizes operation of each of the at least one punching rod 30. Respective bottom sides of the guide slots 124 of each pair of side walls 123 are in a high-low arrangement relative to the base 11 and have respective enlarged sections 125 of different diametric dimensions, which is compatible with various types of shafts.

Although particular embodiments of the invention have been described in detail for purposes of illustration, various modifications and enhancements may be made without departing from the spirit and scope of the invention. Accordingly the invention is not to be limited except as by the appended claims.

1. A hole puncher, including:
a frame, including a base and a guide portion, the base including at least one punching hole, the guide portion including at least one guide hole facing the at least one punching hole, there being a distance between the punching hole and the guide hole;
an operating lever, movably connected to the frame;
at least one punching rod, driven by the operating lever, being relatively movable within the at least one guide hole and movable to be in either presence inside of or outside of the at least one punching hole, each of the at least one punching rod including a first straight section, a second straight section and a tapered section which is tapered from the first straight section toward the second straight section and is movable through one of the at least one guide hole;
wherein at least part of the tapered section of each of the at least one punching rod is in the presence between the at least one punching hole and the at least one guide hole as the at least one punching rod moves through the at least one punching hole and the at least one guide hole.

2. The hole puncher of claim 1, wherein each of the at least one punching rod further includes an expanded section expanding from the tapered section toward the second straight section.

3. The hole puncher of claim 1, wherein the first straight section and the second straight section have the same outer diametric dimension.

4. The hole puncher of claim 1, wherein the first straight section has an extent greater than the distance, and the tapered section is movable to be located between one said punching hole and one said guide hole which correspond to each other.

5. The hole puncher of claim 1, wherein the tapered section includes a largest outer diametric dimension and a smallest outer diametric dimension, and the smallest outer diametric dimension is 0.05 mm to 3.00 mm smaller than the largest outer diametric dimension.

6. The hole puncher of claim 1, wherein the tapered section is necked.

7. The hole puncher of claim 6, wherein the tapered section is inclined to the first straight section at an inclined angle of 5 degrees to 30 degrees.

8. The hole puncher of claim 1, wherein when the second straight section is located within the guide hole, the first straight section is located within the punching hole.

9. The hole puncher of claim 1, wherein the first straight section of each said punching rod includes a long blade portion and a short blade portion which extend toward and are movable through one said punching hole.

10. The hole puncher of claim 7, wherein each of the at least one punching rod further includes an expanded section expanding from the tapered section toward the second straight section; the first straight section and the second straight section are cylindrical and have the same outer diametric dimension; the first straight section an extent greater than the distance, and the tapered section is movable to be located between one said punching hole and one said guide hole which correspond to each other; each said guide hole includes an expanding opening gradually expanding in a direction toward one said punching hole; the tapered section includes a largest outer diametric dimension and a smallest outer diametric dimension, and the smallest outer diametric dimension is 0.05 mm to 3.00 mm smaller than the largest outer diametric dimension; when the second straight section is located within the guide hole, the first straight section is located within the punching hole; the first straight section of each said punching rod includes a long blade portion and a short blade portion which extend toward and are movable through one said punching hole; the guide portion further includes at least one pair of side walls, each said side wall includes a guide slot, the at least one punching rod is slidably disposed within the guide slots of the at least one pair of side walls by at least one shaft, respective bottom sides of the guide slots of each pair of side walls have respective enlarged sections of different diametric dimensions.
